(19) United States
(12) Patent Application Publication
(10) Pub. No.: US 2009/0257103 A1
(43) Pub. Date: Oct. 15, 2009

(54) SYSTEM AND METHOD FOR COLOR ACQUISITION BASED ON HUMAN COLOR PERCEPTION

(76) Inventor: Ronald J. Pellar, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/100,682

(22) Filed: Apr. 10, 2008

(51) Int. Cl. H04N 1/46

(52) U.S. Cl. 358/514

(57) ABSTRACT

The subject application is directed to a system and method for color acquisition based on human color perception. First component image data in a first component region is received from a first associated sensor having a first sensor area. Second component image data in a second component region is then received from a second associated sensor having a sensor area greater than that of the first sensor area, according to a distribution of human eye color receptors corresponding to the first component region and the second component region. The first and second component image data are then processed into image data in a selected luminance-chrominance color space.

### BACKGROUND OF THE INVENTION

The subject application is directed generally to the art of color image acquisition and, more particularly, to acquisition of color image data in a manner that corresponds to human eye characteristics associated with color perception. The subject application is particularly advantageous with respect to acquisition of color image data in a manner that allows for efficient usage and transmission of encoded colorization data.

There is a frequent need to generate data representative of an image to allow for storage, retrieval, editing, transmission, and generating tangible outputs such as printing. Conventional image acquisition is accomplished by use of a scanner. Color scanners will typically include sensors directed to each of a plurality of primary color regions. While any primary color combination is suitable for color image acquisition, conventional color scanners retrieve information via scanning in a red, green, and blue, or RGB, color component system.

Conventional scanning sensor arrays are implemented such that sensor areas are generally equivalent for each primary color input. Such acquisition of data, while effective, generates a substantial amount of data that must be processed for encoding, storage, and transmission.

### SUMMARY OF THE INVENTION

In accordance with one embodiment of the subject application, there is provided a system and method for color acquisition based on human color perception.

Further in accordance with one embodiment of the subject application, there is provided a system and method for the acquisition of color image data in a manner that corresponds to human eye characteristics associated with color perception.

Still further in accordance with one embodiment of the subject application, there is provided a system and method for the acquisition of color image data in a manner that allows for efficient usage and transmission of encoded colorization data.

Still further in accordance with one embodiment of the subject application, there is provided a color scanning system. The system comprises means adapted for receiving first component image data in a first component region from a first associated sensor having a first sensor area. The system also comprises means adapted for receiving second component image data in a second component region from a second associated sensor having a second sensor area greater than the first sensor area, in accordance with a distribution of human eye color receptors corresponding to each of the first component region and the second component regions. The system further includes processing means adapted for processing received first and second component image data into image data in a selected luminance-chrominance color space.

In one embodiment of the subject application, the system further comprises means adapted for receiving third component image data in a third component region from a third associated sensor having a third sensor area greater than the first sensor area and the second sensor area, in accordance with a distribution of human eye color receptors corresponding to each of the component region.

In another embodiment of the subject application, the first component region is green, the second component region is red, and the third component region is blue. In addition, the luminance-chrominance color space is selected from a set comprising L*a*b* and YC_{b}Cᵣ. Preferably, the first sensor area, second sensor area, and third sensor area have a ratio of approximately 1:4:20.

In a further embodiment of the subject application, the system comprises time delay means adapted for supplying a delay to at least one received component image data.

In yet another embodiment of the subject application, the system comprises time delay means adapted for supplying a first delay to the first component image data and a second delay to the second component image data. Preferably, the first delay is defined in accordance with a delay period between a center of the first component image data and the third component image data, and the second delay is defined in accordance with a delay period between a center of the second component image data and the third component image data.

Still further in accordance with one embodiment of the subject application, there is provided a color scanning method in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for color acquisition based on human color perception according to one embodiment of the subject application;

FIG. 2 is a block diagram illustrating device hardware for use in the system for color acquisition based on human color perception according to one embodiment of the subject application;

FIG. 3 is a functional diagram illustrating the device for use in the system for color acquisition based on human color perception according to one embodiment of the subject application;

FIG. 4 is a block diagram illustrating controller hardware for use in the system for color acquisition based on human color perception according to one embodiment of the subject application;

FIG. 5 is a functional diagram illustrating the controller for use in the system for color acquisition based on human color perception according to one embodiment of the subject application;

FIG. 6 is a diagram illustrating an example sensor embodiment for use in the system for color acquisition based on human color perception according to one embodiment of the subject application;

FIG. 7 is a block diagram illustrating a method for color acquisition based on human color perception according to one embodiment of the subject application;

FIG. 8 is a flowchart illustrating a method for color acquisition based on human color perception according to one embodiment of the subject application; and

FIG. 9 is a flowchart illustrating a method for color acquisition based on human color perception according to one embodiment of the subject application.

### DETAILED DESCRIPTION OF THE PREFERRED EMBODIMENT

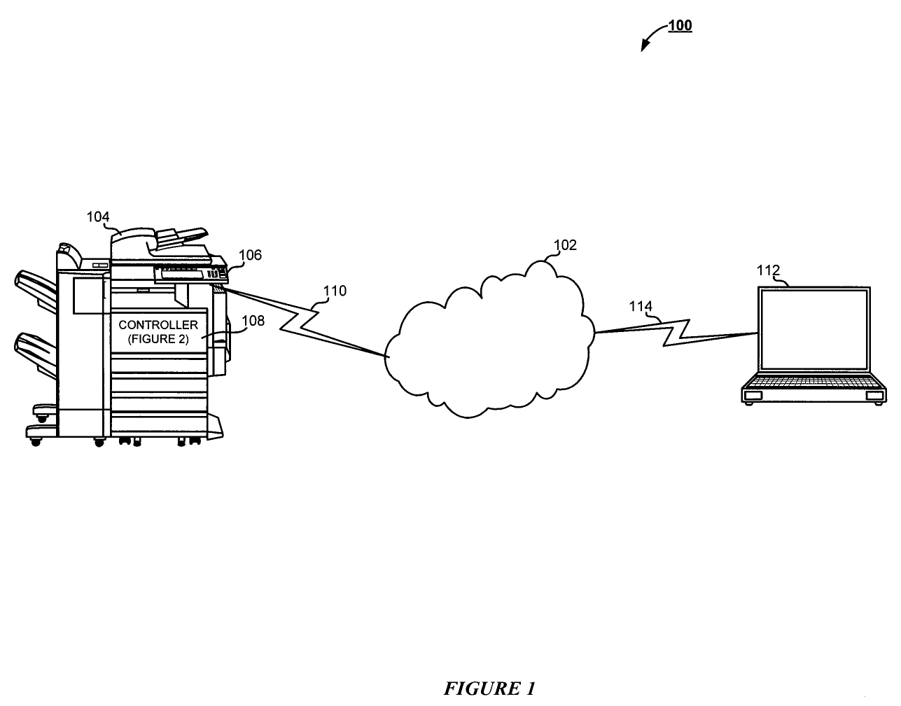

The subject application is directed to a system and method for color acquisition based on human color perception. In particular, the subject application is directed to a system and method for the acquisition of color image data in a manner that corresponds to human eye characteristics associated with color perception. More particularly, the subject application is directed to a system and method for the acquisition of color image data in a manner that allows for efficient usage and transmission of encoded colorization data. It will become apparent to those skilled in the art that the system and method described herein are suitably adapted to a plurality of varying electronic fields employing color processing including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of the system 100 for color acquisition based on human color perception in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

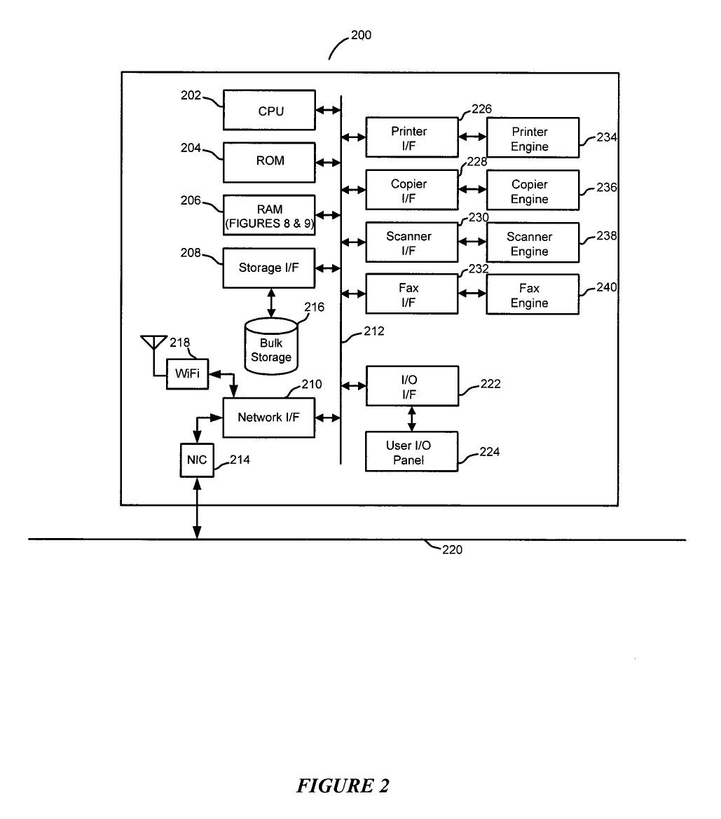

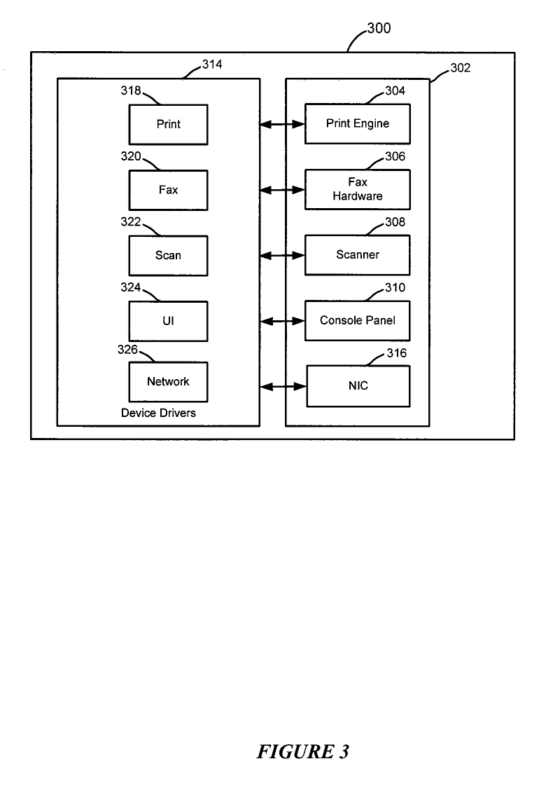

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially-available document processing devices include, for example and without limitation, the TOSHIBA e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106 such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; receive input from the associated user; and communicate the same to a backend component, such as a controller 108, as explained in greater detail below. Preferably, the document processing device 104 is communicatively coupled to the computer network 102 via a suitable communications link 110. As will be understood by those skilled in the art, suitable communications links include, for example and without limitation, WIMAX, 802.11a, 802.11b, 802.11g, 802.11(x), BLUETOOTH, the public switched telephone network, a proprietary communications network, infrared, optical, or any other suitable wired or wireless data transmission communications known in the art.

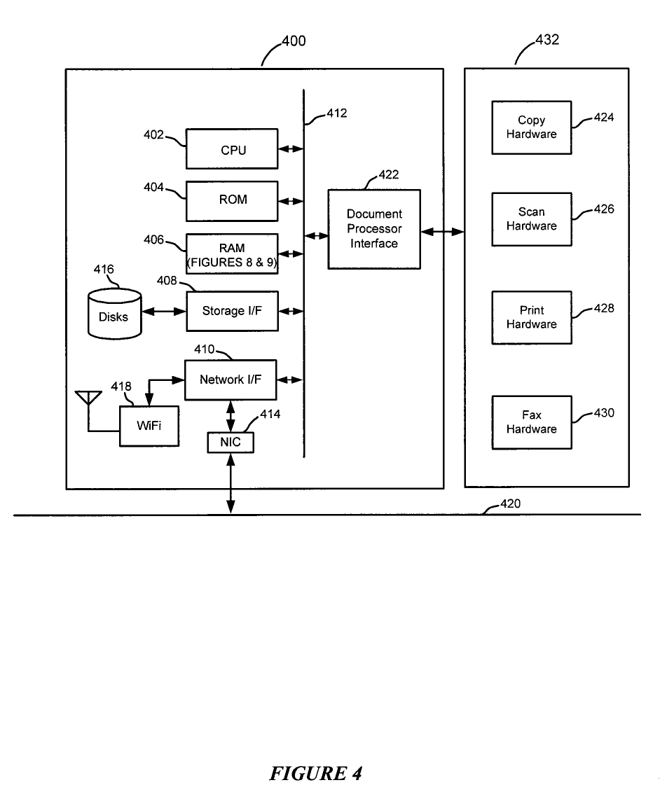

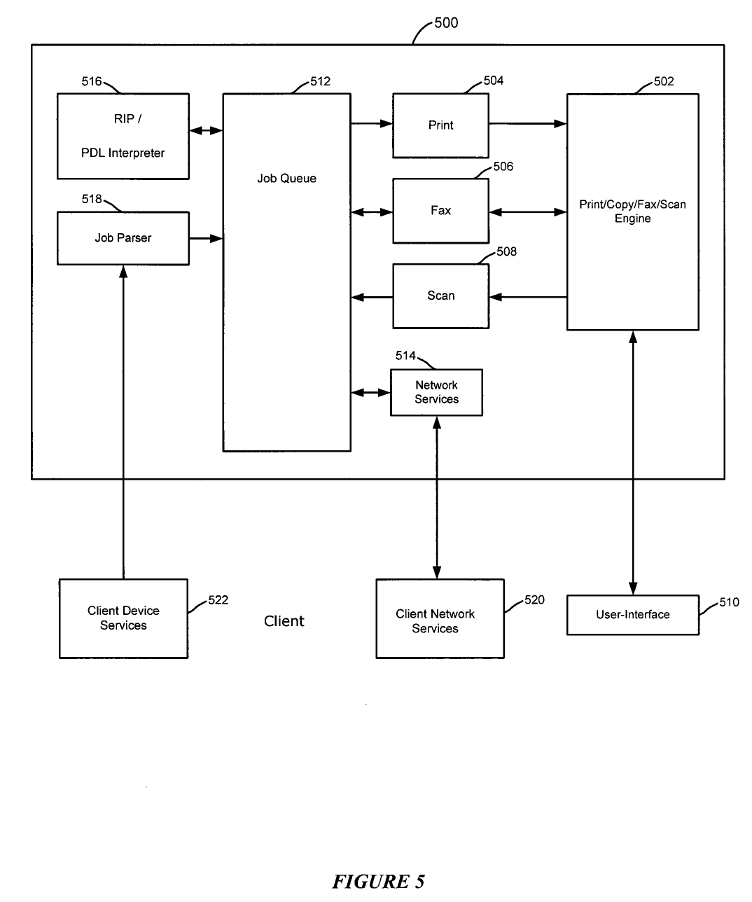

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for color acquisition based on human color perception of the subject application. The functioning of the controller 108 will better be understood in conjunction with the block diagrams illustrated in FIGS. 4 and 5, explained in greater detail below.

The system 100 illustrated in FIG. 1 further depicts a user device 112 in data communication with the computer network 102 via a communications link 114. It will be appreciated by those skilled in the art that the user device 112 is shown in FIG. 1 as a laptop computer for illustration purposes only. As will be understood by those skilled in the art, the user device 112 is representative of any personal computing device known in the art including, for example and without limitation, a computer workstation, a personal computer, a personal data assistant, a web-enabled cellular telephone, a smart phone, a proprietary network device, or other web-enabled electronic device. The communications link 114 is any suitable channel of data communications known in the art including but not limited to wireless communications, for example and without limitation, BLUETOOTH, WIMAX, 802.11a, 802.11b, 802.11g, 802.11(x), a proprietary communications network, infrared, optical, the public switched telephone network, or any suitable wireless data transmission system or wired communications known in the art. Preferably, the user device 112 is suitably adapted to generate and transmit electronic documents, document processing instructions, user interface modifications, upgrades, updates, personalization data, or the like to the document processing device 104 or any other similar device coupled to the computer network 102.

Turning now to FIG. 2, illustrated is a representative architecture of a suitable device 200, illustrated in FIG. 1 as the document processing device 104, on which operations of the subject system are completed. Included is a processor 202 suitably comprised of a central processor unit. However, it will be appreciated that the processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the server 200 is random access memory 206 suitably formed of dynamic random access memory, static random access memory, or any other suitable, addressable memory system. Random access memory 206 provides a storage area for data instructions associated with applications and data handling accomplished by the processor 202.

A storage interface 208 suitably provides a mechanism for volatile, bulk, or long term storage of data associated with the device 200. The storage interface 208 suitably uses bulk storage such as any suitable addressable or serial storage, such as a disk, optical, tape drive, and the like, as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, token ring, and the like, and a wireless interface 218 suitably adapted for wireless communication via means such as WIFI, WIMAX, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Suitable executable instructions on the device 200 facilitate communication with a plurality of external devices such as workstations, document processing devices, other servers, or the like. While in operation a typical device 200 operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300 for use in connection with the disclosed system. FIG. 3 illustrates suitable functionality of the hardware of FIG. 2 in connection with software and operating system functionality, as will be appreciated by one of ordinary skill in the art. The document processing device 300, depicted in FIG. 1 as the document processing device 104, suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device known in the art that is capable of facilitating the methodologies described herein. Included is a processor 402 suitably comprised of a central processor unit. However, it will be appreciated that processor 402 may advantageously be composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable, addressable, and writable memory system. Random access memory 406 provides a storage area for data instructions associated with applications and data handling accomplished by processor 402.

A storage interface 408 suitably provides a mechanism for non-volatile, bulk, or long term storage of data associated with the controller 400. The storage interface 408 suitably uses bulk storage such as any suitable addressable or serial storage, such as a disk, optical, tape drive and the like, as shown as 416, as well as any suitable storage medium, as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, token ring, and the like, and a wireless interface 418 suitably adapted for wireless communication via means such as WIFI, WIMAX, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface card 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. A suitable controller functionality is that incorporated into the TOSHIBA e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that may provide any one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter, or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, first component image data in a first component region is received from a first sensor having a first sensor area. Second component image data in a second component region is then received from a second associated sensor having a sensor area greater than that of the first sensor area, according to a distribution of human eye color receptors corresponding to the first component region and the second component region. The first and second component image data is then processed into image data in a selected luminance-chrominance color space.

In accordance with one example embodiment of the subject application, red, green, and blue image data is received via a scanning component or other suitable means associated with the document processing device 104. For example, an RGB (red, green, blue) image is received from the user device 112 via the computer network 102 for image processing by the document processing device 104. It will be understood by those skilled in the art that other means, as are known in the art, of receiving image data for processing by the document processing device 104 are capable of being employed in accordance with the subject application. As the skilled artisan will appreciate, the scanning component includes a plurality of image sensors, each sensor capable of receiving image data in a corresponding component region, e.g., green component region, red component region, blue component region, or the like. The image data is then communicated to a suitable backend component, such as the controller 108, associated with the document processing device 104 for processing. It will be apparent to those skilled in the art that use of the document processing device 104 is for example purposes only, and any suitable processing device such as, for example and without limitation, a laptop computer, a workstation, a personal computer, or the like is equally capable of implement the subject application for image processing.

Accordingly, image data in a green component region is received by controller 108, other suitable component associated with the document processing device 104, or other suitable processing device, from a green sensor having a corresponding first sensor area. A suitable delay is then supplied to the green sensor data prior to processing. The skilled artisan will appreciate that the function of the delay, as well as the length of the delay, will be explained in greater detail below. Image data in a red component region is also received by the controller 108, other suitable component associated with the document processing device 104, or other suitable processing device, from a corresponding red sensor having a second sensor area. Preferably, the second sensor area, or that which is associated with the red sensor, is greater than the first sensor area, or that associated with the green sensor. The skilled artisan will appreciate that such a distinction in sensor area is in accordance with a distribution of human eye color receptors corresponding to the green and red component regions of the received image data. The skilled artisan will appreciate that the human eye has a spatial distribution of color receptors that is generally in a ratio of 1:4:20 relative to green:red:blue.

The controller 108, other suitable component associated with the document processing device 104, or other suitable processing device then supplies a suitable delay to the red sensor data. As with the green sensor data, the function and length of the delay associated with the red sensor data will be discussed in further detail below. The controller 108, other suitable component associated with the document processing device 104, or other suitable processing device also receives image data in a blue component region from a blue sensor having a third sensor area. Preferably, the third, or blue, sensor area is greater than both the first (green) and second (red) sensor areas, in accordance with the distribution of human eye color receptors corresponding to each of the green, red, and blue component regions. The skilled artisan will appreciate that such a distribution corresponds generally to an area size ratio of 1:4:20, respectively, with respect to the green, red, and blue sensor area sizes.

In accordance with this example embodiment of the subject application, the delay supplied to the green sensor corresponds to a delay period between a center of the first component image data and the third component image data. Stated another way, the green sensor is time delayed, e.g., the signal converted to digital data and buffered or subject to an analog delay line, to match the scanning time delay between the center of the green component region (image sensor data) and the blue component region (image sensor data). Thus, the skilled artisan will appreciate that, as the blue sensor area is suitably twenty (20) times the size of the green sensor area (according to the 1:4:20 human eye perception), the green sensor data is delayed by a factor of twenty (20) so as to enable the complete receipt of the blue sensor image data. Similarly, the delay supplied to the red sensor image data is appropriately delayed to match the scanning time delay between the center of the red component region (image sensor data) and the blue component region (image sensor data). As with the green sensor image data, the delay is capable of being implemented by conversion of the red data to a digital format and appropriate buffering in memory associated with the controller 108, or subjected to an analog delay line matching the delay associated with the complete receipt of the blue data.

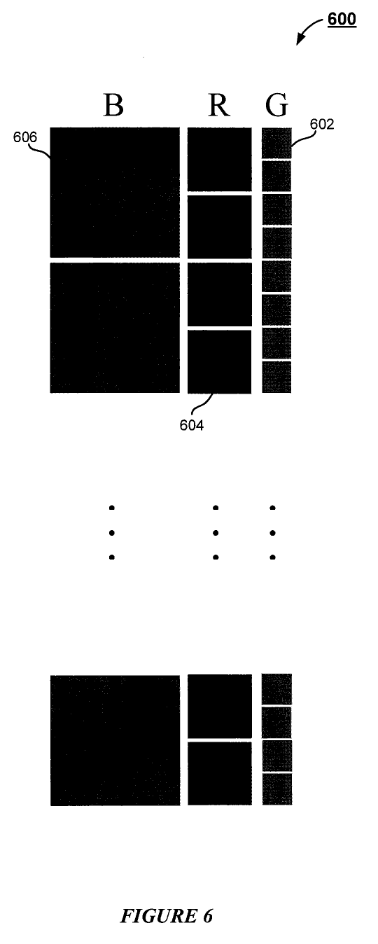

FIG. 6 illustrates at 600 the relative size of the sensor areas, demonstrating the corresponding sizes the green, red, and blue sensors in accordance with one example embodiment of the subject application. As shown in FIG. 6, the green sensors 602 constitute the smallest sensor area. The red sensors 604 are approximately twice the size of the green sensors 602, thus having four (4) times the area of the green sensors 602. Last and largest are the blue sensors 606, which are four (4) times the size of the green sensors 602, having sixteen (16) times the area. Thus, as will be understood by those skilled in the art, the bandwidth for the red component region would be half the bandwidth for the green component region, and the bandwidth for the blue component region would be one fourth the bandwidth for the green component region. The skilled artisan will appreciate that such an implementation of the subject application results in a lesser number of sensors in the red and blue component regions than those for the green, thereby reducing associated manufacturing costs.

Once all component image data has been received, a determination is made as to whether a gamma correction function, as is known in the art, is to be applied to the received component image data. When no application of a gamma correction function is required, the image data received from the sensors is processed via application of a suitable matrix to convert the image data to a desired luminance-chrominance color space. Thereafter, the processed image data is output in the selected luminance-chrominance color space, e.g., YC_{b}Cᵣ color space or L*a*b* color space. When the controller 108, another suitable component associated with the document processing device 104, or other suitable processing device determines that a gamma correction function should be applied, the appropriate gamma function is applied to the received component image data. Thereafter, the gamma corrected image data is input into a matrix so as to obtain the appropriate luminance-chrominance color space output. The processed image data is then output in the selected luminance-chrominance color space, e.g., YC_{b}Cᵣ color space or L*a*b* color space.

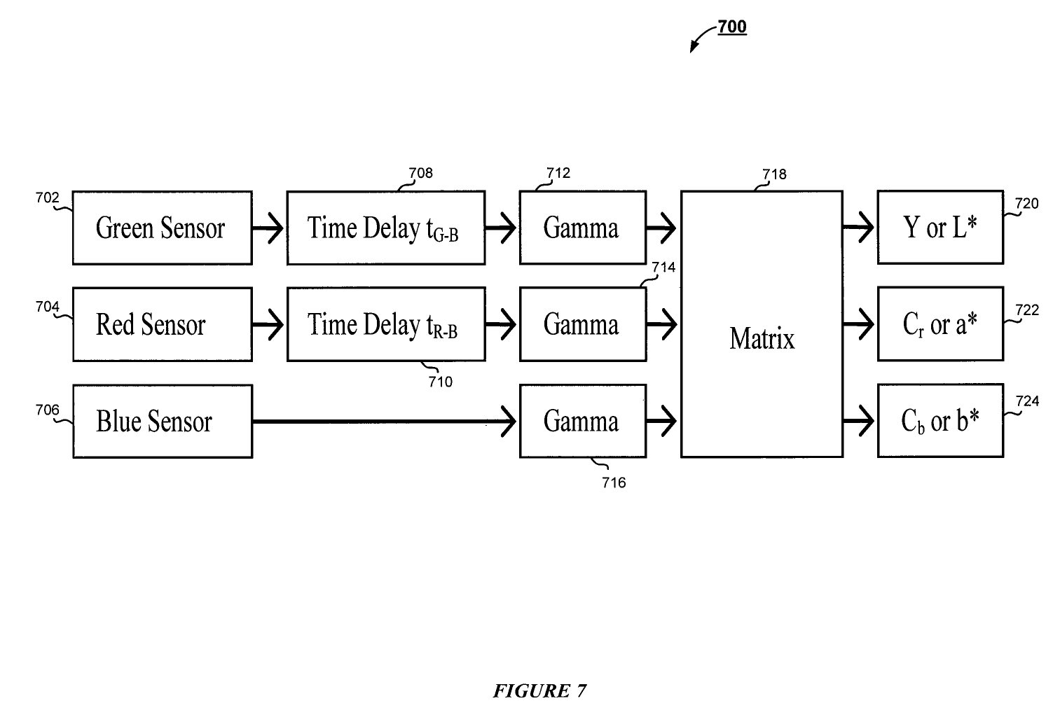

Turning now to FIG. 7, there is shown a block diagram 700 illustrating the operation of the system as set forth in the preceding description. As shown in FIG. 7, the diagram includes a green sensor 702, a red sensor 704, and a blue sensor 706. The output from the green sensor 702 is then subjected to time delay 708 representing the scanning time delay between the center of the green sensor 702 and the blue sensor 706. The output from the red sensor 704 is also subjected to a time delay 710 representing the scanning time delay between the center of the red sensor 704 and the blue sensor 706. As depicted in the diagram 700 of FIG. 7, the output of the green-blue time delay 708 is subjected to a suitable gamma function 712, the output of the red-blue time delay 710 is subjected to a suitable gamma function 714, and the output of the blue sensor 706 is subjected to a suitable gamma function 716. Thereafter, the gamma correction outputs from the gamma correction functions 712-716 are input into a matrix 718, reflecting the appropriate luminance-chrominance color space conversions. The output of the matrix 718 is shown as the luminance-chrominance outputs 720, 722, and 724. The skilled artisan will appreciate that, as shown in FIG. 7, the output 720 reflects the luminance Y or L* component of the selected luminance-chrominance color space (e.g., YC_{b}Cᵣ or L*a*b*), the output 722 reflects the chrominance Cᵣ or a* component of the selected luminance-chrominance color space, and the output 724 reflects the chrominance C_{b} or b* component of the selected luminance-chrominance color space.

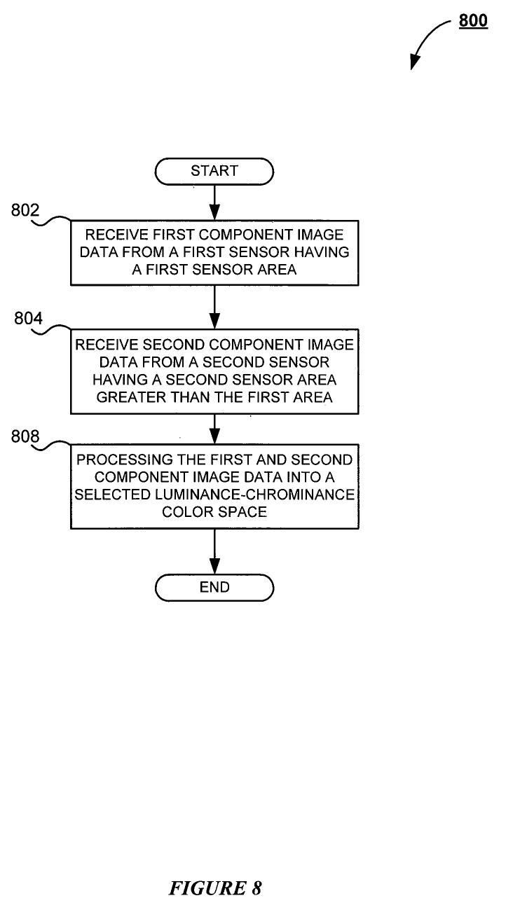

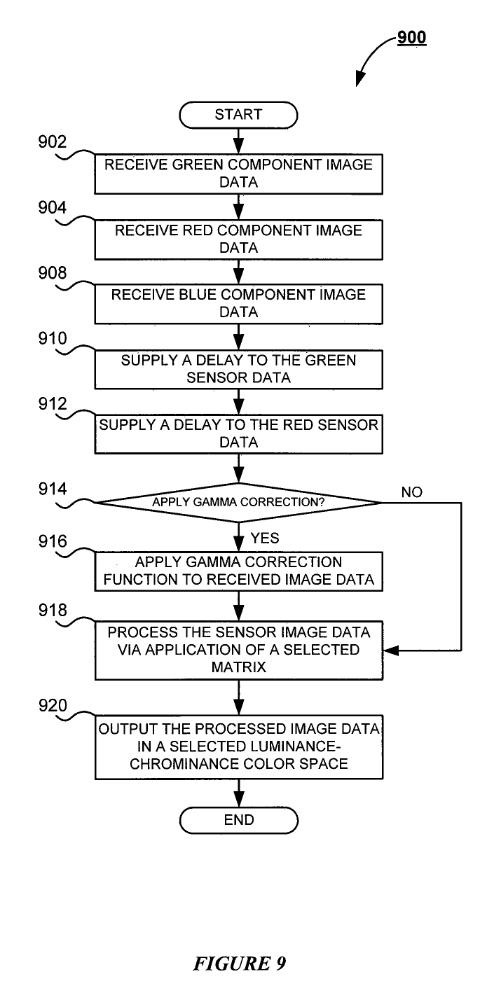

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for color acquisition based on human color perception in accordance with one embodiment of the subject application. Beginning at step 802, first component image data is received from a first associated sensor having a first sensor area. At step 804, second component image data is received from a second associated sensor. Preferably, the second sensor has a second sensor area greater than the first sensor area, in accordance with a distribution of human eye color receptors corresponding to each of the first component region and the second component region. Flow then proceeds to step 808, whereupon the first and second component image data are processed into a selected luminance-chrominance color space.

Referring now to FIG. 9, there is shown a flowchart 900 illustrating a method for color acquisition based on human color perception in accordance with one embodiment of the subject application. The method illustrated in the flowchart 900 of FIG. 9 corresponds to one example embodiment of the subject application and, as such, the skilled artisan will appreciate that other embodiments are capable of implementation in accordance with the system and method described above. Furthermore, while reference is made with respect to FIG. 9 as applying to a document processing device 104, the skilled artisan will appreciate that any suitable electronic processing device is capable of implementing the subject application and performing the steps described herein, including, for example and without limitation, a personal computer, a workstation, server, laptop computer, or other personal electronic processing device.

The method of FIG. 9 begins at step 902, whereupon green component image data in a green component region is received by the controller 108 or other suitable component associated with the document processing device 104 from an associated green sensor. It will be appreciated by those skilled in the art that the image data received by the document processing device 104 is capable of being generated by the document processing device 104 via a suitable scanning operation, received by the document processing device 104 over the computer network 102 from an associated user device 114, received from a suitable storage device accessible by the document processing device 104, or the like. At step 904, red component image data in a red component region is received by the controller 108, or other suitable component associated with the document processing device 104, from an associated red sensor. Preferably, the red sensor area is greater than the green sensor area, in accordance with a distribution of human eye color receptors corresponding to the green component region and the red component region. At step 908, blue component image data in a blue component region is received from a blue sensor by the controller 108 or other suitable component of the document processing device 104. Preferably, the blue sensor area is greater than the green sensor area and the red sensor area, according to the distribution of human eye color receptors corresponding to each of the green, red, and blue component regions.

A green-blue delay is then supplied to the received green image data at step 910. Preferably, the green-blue delay is defined in accordance with a delay period between a center of the green component image data and blue component image data. At step 912, a red-blue delay is supplied to the received red component image data. In accordance with this embodiment of the subject application, the red-blue delay is defined in accordance with a delay period between the center of the red component image data and blue component image data.

At step 914, a determination is then made by the controller 108 or other suitable component associated with the document processing device 104 as to whether a gamma correction function needs to be applied to the received green, red, and blue component image data. When the application of a gamma correction is required, flow proceeds to step 916, whereupon the appropriate gamma correction function is applied to the green component image data, the red component image data, and the blue component image data. When no such gamma correction is necessary, flow bypasses step 916 to step 918, whereupon the received component image data is processed via the application of a selected matrix. The skilled artisan will appreciate that such a matrix is used to facilitate the conversion of the component image data into a desired luminance-chrominance color space, e.g., L*a*b*, YC_{b}Cᵣ, or the like. Thereafter, the processed image data is output in the selected luminance-chrominance color space at step 920. That is, the image data is output having a luminance component Y or L*, a chrominance Cᵣ or a* component, and a chrominance C_{b} or b* component of the selected luminance-chrominance color space.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A color scanning system comprising:
means adapted for receiving first component image data in a first component region from a first associated sensor having a first sensor area;
means adapted for receiving second component image data in a second component region from a second associated sensor having a second sensor area greater than the first sensor area, in accordance with a distribution of human eye color receptors corresponding to each of the first component region and the second component region; and
processing means adapted for processing received first and second component image data into image data in a selected luminance-chrominance color space.

2. The color scanning system of claim 1, further comprising means adapted for receiving third component image data in a third component region from a third associated sensor having a third sensor area greater than the first sensor area and the second sensor area, in accordance with a distribution of human eye color receptors corresponding to each of the component regions.

3. The color scanning system of claim 2, wherein:
the first component region is green;
the second component region is red;
the third component region is blue; and
the luminance-chrominance color space is selected from a set comprising L*a*b* and YC_{b}Cᵣ.

4. The color scanning system of claim 3, wherein the first sensor area, second sensor area, and third sensor area have a ratio of approximately 1:4:20.

5. The color scanning system of claim 4, further comprising time delay means adapted for supplying a delay to at least one received component image data.

6. The color scanning system of claim 5, further comprising time delay means adapted for supplying a first delay to the first component image data and a second delay to the second component image data.

7. The color scanning system of claim 6, wherein:
the first delay is defined in accordance with a delay period between a center of the first component image data and the third component image data; and
the second delay is defined in accordance with a delay period between a center of the second component image data and the third component image data.

8. A color scanning method comprising the steps of:
receiving first component image data in a first component region from a first associated sensor having a first sensor area;
receiving second component image data in a second component region from a second associated sensor having a second sensor area greater than the first sensor area, in accordance with a distribution of human eye color receptors corresponding to each of the first component region and the second component region; and
processing received first and second component image data into image data in a selected luminance-chrominance color space.

9. The color scanning method of claim 8, further comprising the step of receiving third component image data in a third component region from a third associated sensor having a third sensor area greater than the first sensor area and the second sensor area, in accordance with a distribution of human eye color receptors corresponding to each of the component regions.

10. The color scanning method of claim 9, wherein:
the first component region is green;
the second component region is red;
the third component region is blue; and
the luminance-chrominance color space is selected from a set comprising L*a*b* and YC_{b}Cᵣ.

11. The color scanning method of claim 10, wherein the first sensor area, second sensor area, and third sensor area have a ratio of approximately 1:4:20.

12. The color scanning method of claim 11, further comprising the step of supplying a delay to at least one received component image data.

13. The color scanning method of claim 12, further comprising the step of supplying a first delay to the first component image data and a second delay to the second component image data.

14. The color scanning method of claim 13, wherein:
the first delay is defined in accordance with a delay period between a center of the first component image data and the third component image data; and
the second delay is defined in accordance with a delay period between a center of the second component image data and the third component image data.

15. A computer-implemented method for color scanning comprising the steps of:
receiving first component image data in a first component region from a first associated sensor having a first sensor area;
receiving second component image data in a second component region from a second associated sensor having a second sensor area greater than the first sensor area, in accordance with a distribution of human eye color receptors corresponding to each of the first component region and the second component region; and
processing received first and second component image data into image data in a selected luminance-chrominance color space.

16. The computer-implemented method for color scanning of claim 15, further comprising the step of receiving third component image data in a third component region from a third associated sensor having a third sensor area greater than the first sensor area and the second sensor area, in accordance with a distribution of human eye color receptors corresponding to each of the component regions.

17. The computer-implemented method for color scanning of claim 16, wherein:
the first component region is green;
the second component region is red;
the third component region is blue; and
the luminance-chrominance color space is selected from a set comprising L*a*b* and YC_{b}Cᵣ.

18. The computer-implemented method for color scanning method of claim 17, wherein the first sensor area, second sensor area, and third sensor area have a ratio of approximately 1:4:20.

19. The computer-implemented method for color scanning of claim 18 further comprising the step of supplying a first delay to the first component image data and a second delay to the second component image data.

20. The computer-implemented method for color scanning of claim 19, wherein:
the first delay is defined in accordance with a delay period between a center of the first component image data and the third component image data; and
the second delay is defined in accordance with a delay period between a center of the second component image data and the third component image data.
